(19) United States
(12) Patent Application Publication
(10) Pub. No.: US 2026/0148369 A1
(43) Pub. Date: May 28, 2026

(54) METHODS AND SYSTEMS FOR AUTOMATED STRUCTURE ASSESSMENT USING UAV-BASED PHOTOGRAMMETRY AND AI-ENHANCED SEGMENTATION, SCORING, AND ANALYSIS

(71) Applicant: Drone Institute, LLC, Lafayette, LA (US)

(72) Inventors: Nan Shang, Lafayette, LA (US); George Femmer, Lafayette, LA (US); Christopher Sharplin, Opelousas, LA (US)

(21) Appl. No.: 19/402,948

(22) Filed: Nov. 26, 2025

Related U.S. Application Data
(60) Provisional application No. 63/725,162, filed on Nov. 26, 2024.

(51) Int. Cl. G06T 7/00; G05D 1/689; G05D 101/15; G05D 105/80; G05D 109/20; G05D 111/10; G06T 3/4038; G06T 7/12; G06T 17/05; G06V 10/70; G06V 20/10; G06V 20/17

(52) U.S. Cl. CPC G06T 7/0008; G05D 1/689; G06T 3/4038; G06T 7/12; G06T 17/05; G06V 10/70; G06V 20/17; G06V 20/176; G05D 2101/15; G05D 2105/89; G05D 2109/20; G05D 2111/10; G06T 2207/10032; G06T 2207/30184

(57) ABSTRACT

The present technology relates to methods and systems for assessing a spatial area based on an at least one condition. The methods can include deploying an deploying an unmanned aerial vehicle (UAV) equipped with imaging technology; capturing images of a spatial area within a geographically selected region, wherein the region is selected based on data indicating potential of the at least one condition; processing the captured images to generate three-dimensional (3D) models and two-dimensional (2D) orthomosaics of the spatial area; and analyzing the generated 3D models and 2D orthomosaics using a machine learning algorithm configured to detect the at least one condition. The systems can comprise: a drone configured to capture aerial images; a computing device equipped to process the images into 3D models and 2D orthomosaics; and a machine learning module configured to analyze the models and mosaics to identify instances of the at least one condition.

### CROSS-REFERENCE TO RELATED APPLICATIONS

This application claims the benefit of U.S. Provisional Application No. 63/725,162 filed Nov. 26, 2024, which is hereby incorporated by reference in its entirety.

### BACKGROUND

The present disclosure relates in general to the automated assessment of structure condition, and in particular to systems and methods for assessing conditions of interest, such as damage, to structural components such as a building roofs and surfaces.

Traditional methods for monitoring and assessment of the exterior condition of a building or other structure may be largely manual in nature. Active assessment requires substantial effort from well-trained individuals. For example, assessing a home or commercial building for roof damage may require a trained individual to climb up on the structure's roof and perform a manual evaluation. Such evaluations are usually time-consuming and costly. On some structures, individuals may have to climb high or far into desired positions, incurring some amount of safety risk. Certain areas may be difficult to manually inspect. Certain types of roofs, such as tile roofs, may be prone to damage caused by the inspection process itself.

Meanwhile, extreme weather events causing damage to roofs and other structural components, such as tornados, hurricanes, hail, and torrential storms, appear to arrive with increasing frequency. Evaluating structural damage after a natural disaster in a highly populated area may consume substantial amounts of time and resources, even before repairs begin. The building maintenance and insurance industries, in particular, have struggled with the lack of comprehensive and scalable data when determining the extent of damage across roofing systems. This challenge is compounded by the differing interests and capabilities of the stakeholders involved, including insurance carriers, roofing contractors, and property owners, who often face conflicts due to subjective assessments and incomplete data.

For these and other reasons, it is desirable to provide systems and methods for automated assessment of a structure's exterior. Particularly desirable are such systems and methods that can provide reliable and meaningful data at minimal cost.

Prior efforts have been made to provide for structure condition evaluation, including: U.S. Pat. No. 11,508,014 B1—Structural Characteristic Extraction Using Drone Generated 3D Image Data (State Farm); U.S. Pat. No. 9,805,261 B1—Systems and Methods for Surface and Subsurface Damage Assessments Patch Scans and Visualization (Loveland Innovations); U.S. Pat. No. 9,875,509 B1—Method and System for Determining the Condition of Insured Properties in a Neighborhood (State Farm); U.S. Pat. No. 10,134,092 B1—Method and System for Assessing Damage to Insured Properties in a Neighborhood (State Farm); and U.S. Pat. No. 10,402,676 B2—Automated system and methodology for feature extraction (Pictometry); the contents of which are incorporated herein by reference.

### BRIEF SUMMARY

In certain embodiments, evaluation of structure conditions, such as roof damage, is performed utilizing unmanned aerial vehicles (UAVs) equipped with advanced imaging technologies and artificial intelligence. Drone-captured photogrammetry and AI-enhanced analysis can be leveraged to perform detailed and accurate assessments of e.g., roof conditions, including those of residential and commercial buildings.

Various other objects, features, aspects, and advantages of the present technology and embodiments will become more apparent from the following detailed description, along with the accompanying drawings in which numerals represent like components.

In certain embodiments, the present disclosure is directed a method of assessing a spatial area based on an at least one condition, comprising: deploying an unmanned aerial vehicle (UAV) equipped with photogrammetric imaging technology; capturing images of a spatial area within a geographically selected region, wherein the region is selected based on data indicating potential of the at least one condition; processing the captured images to generate three-dimensional (3D) models and two-dimensional (2D) orthomosaics of the spatial area; and analyzing the generated 3D models and 2D orthomosaics using a machine learning algorithm configured to detect the at least one condition.

In other embodiments, the present disclosure is directed to a system for assessing a spatial area, such as a structure, based on an at least one condition, the system comprising: a drone configured to capture aerial images; a computing device equipped to process the images into 3D models and 2D orthomosaics; and a machine learning module configured to analyze the models and mosaics to assess the spatial area based on the at least one condition to identify instances of the at least one condition.

In other embodiments, the present disclosure is directed to a method of quantifying at least one condition, the method comprising: capturing aerial images of a spatial area using an unmanned aerial vehicle (UAV) equipped with photogrammetric imaging technology; processing the captured images to generate segmented two-dimensional (2D) orthomosaics and three-dimensional (3D) models of the spatial area; analyzing the segmented images to determine an at least one boundary of the spatial area affected by the at least one condition; quantifying a score for the at least one boundary of the spatial area affected by the at least one condition based on the analysis; and generating a tabulated report that lists the quantified score, the area of the at least one boundary affected, and recommended actions.

### BRIEF DESCRIPTION OF THE DRAWINGS

FIG. 1 is a schematic block diagram of an exemplary system for automated structure assessment.

FIG. 2 shows a process for an exemplary structure assessment using UAV imagery data.

FIG. 3 shows an exemplary process for analyzing UAV imagery data and generating structure assessment reporting.

FIG. 4A is a representative map of the capture of aerial images in accordance with certain embodiments herein.

FIG. 4B shows an exemplary embodiment of a two-dimensional (2D) orthomosaic of a spatial area resulting from the captured images of FIG. 4A;

FIG. 4C is the two-dimensional (2D) orthomosaic of FIG. 4B segmented by boundaries of interest and further segmented by condition of interest.

FIG. 5A shows an embodiment of a two-dimensional (2D) orthomosaic of the captured images segmented by boundaries of interest;

FIG. 5B shows the information of FIG. 5A further segmented by slopes.

FIG. 5C shows the information of FIG. 5B further segmented by condition of interest.

FIG. 6 shows an exemplary embodiment of an analyzed spatial area.

### DETAILED DESCRIPTION

As used herein, all singular terms refer to both singular and plural values. That is, “a” or “an” or “the” all mean “one or more.” The term “or” as used herein means any one or more of the alternatives, including all of the alternatives.

Throughout the present disclosure, when described in sequential words (for example, using “then” or “next”), such description is not limiting to the described steps in the particular order set forth, but also includes embodiments wherein the steps are presented in any order.

As used herein, “artificial intelligence” or “A.I.” means the simulation of human intelligence processes by machines, in particular, computer systems, including the ability to learn, read, write, create, and analyze. As used herein, “generative A.I.” means A.I. that is capable of generative text, images or other data using generative models, which learn the patterns and structure of their input training data and then generate new data that has similar characteristics. As used herein, “large language models” (LLMs) are a type of generative A.I. that can be multi-modal (as used in images, text or video). Further, as used herein, “machine learning” is a subset of A.I. implemented by various techniques.

As used herein, “photogrammetry” means the science and technology of obtaining reliable information about physical objects and the environment through the process of recording, measuring and interpreting photographic images and patterns of electromagnetic radiant imagery and other phenomena, including but not limited to, methods of approximating a three-dimensional (“3D”) structure using two dimensional (“2D”) images. As used herein, “photogrammetric” means pertaining to photogrammetry or containing properties necessary for photogrammetry.

While the present technology is susceptible to embodiment in many different forms, there are shown in the drawings and will be described in detail herein several embodiments, with the understanding that the present disclosure is to be considered as an exemplification of the principles of the technology to enable any person skilled in the art to make and use the technology, and is not intended to limit the technology to the embodiments illustrated.

Certain embodiments are particularly applicable in the context of building maintenance, insurance assessment, and disaster response, where rapid and reliable evaluations of structural integrity are important. The system and methods described herein can integrate aerial imagery with sophisticated machine learning algorithms to detect, analyze, and classify a condition of interest such as roof damage.

The analysis can include the identification of various types of conditions of interest within broad categories including but not limited to roofs, buildings, oil rigs (including offshore oil rigs located in water), or vehicles. Within the category of roofs, a nonexhaustive list of conditions of interest can include: shingle displacement, granular loss, and structural deformities, which can be important for determining the health of a roof and making informed decisions regarding maintenance, repair, or insurance claims. For example, insurance carriers may desire accurate damage assessments to process claims efficiently and avoid payouts for undamaged or minimally damaged areas. Roofing contractors, on the other hand, need precise and reliable data to recommend appropriate repair or replacement services, ensuring that they address all necessary repairs without over or underestimating the work required. Property owners seek transparency and fairness in the reporting of damage and estimate of costs, to ensure that claims and repairs are handled promptly and justly.

To that end, the systems and methods herein can, in certain embodiments, be implemented for automated condition of interest, such as damage, assessment of a spatial area of interest, such as a roof, oil tank, or other structure, using UAVs with photogrammetric imaging technology and enhanced by artificial intelligence. This technology can allow for the systematic capture of aerial images of spatial areas of interest, such as roofs, oil tanks, or other structures, which can then be processed to generate detailed 3D models and 2D orthomosaics. These models can provide a segmented and highly accurate representation of the spatial areas of interest, and highlight conditions of interest, such as areas affected by wear, tear, and severe damage.

By leveraging advanced algorithms, the systems and methods herein can analyze these images to quantify the condition of interest, such as the extent of damage in terms of area and severity. In certain embodiments, the AI-driven analysis can differentiate between varying degrees of a condition of interest and categorize the condition of interest, thereby standardizing assessments and making assessments reproducible and scalable across multiple spatial areas within the image. This process not only increases the accuracy of the assessments but also speeds up the process, enabling rapid responses that are particularly important following natural disasters.

Furthermore, in some embodiments, the system generates comprehensive reports that tabulate the quantified condition and recommend particular actions, such as repair and replacement. These reports are designed to be easily interpretable by both technical and non-technical stakeholders, providing all parties with reliable data that can support informed decision-making. This capability can dramatically improve the interactions between insurance carriers, roofing contractors, and property owners by providing a common ground of trustable data, reducing conflicts, and enhancing the efficiency of claim processing and roof repair management.

Overall, the embodiments herein can increase the accuracy and efficiency of assessments as well as facilitate better communication and decision-making among all stakeholders involved. The system and methods described herein can not only streamline workflows but can also contribute to substantial cost savings and enhanced satisfaction for property owners, ultimately leading to more resilient and well-maintained properties.

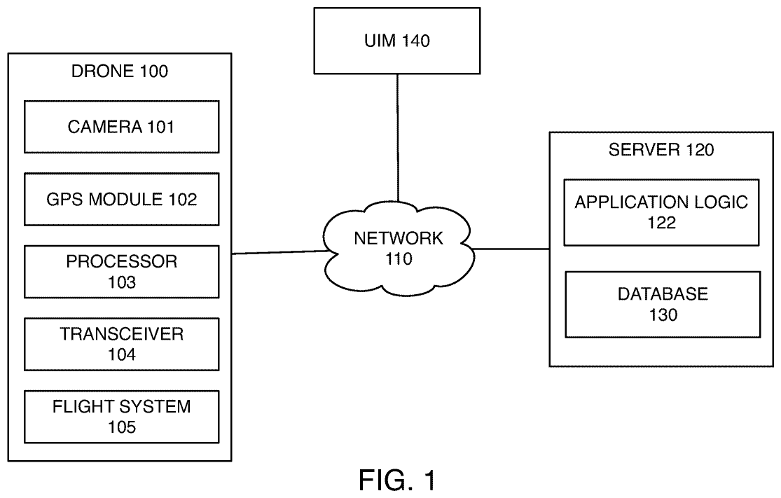

FIG. 1 is a schematic block diagram of an exemplary system for automated structure assessment using UAV equipped with imaging devices. The system shown integrates drone-based data acquisition with deep learning models to evaluate a spatial area of interest, such as a roof, and identify predetermined conditions, such as damage, and generate detailed condition or repair reports. The system shown therein comprises a drone 100, a communications network 110, a server 120, a storage database 130 and a user interface module 140.

Drone 100 is an unmanned aerial vehicle equipped with a camera 101, GPS module 102, onboard processor 103, transceiver 104, and flight systems 105. Camera 101 captures detailed images or videos of building roofs during flight operations. GPS module 102 records the geolocation data for each image, facilitating precise mapping, and also provides location information for use by flight systems 105. Onboard processor 103 can perform preliminary data processing and manage flight operations in conjunction with flight systems 105. Transceiver 104 permits bidirectional communications between drone 100 and other systems, such as a drone pilot controller for manual control of drone 100, or an external computing device such as server 120 or user interface module 140 for e.g., offloading camera footage and other data from drone 100. Transceiver 104 can include a Wi-Fi radio, cellular communication systems, Bluetooth communication systems, or dedicated RF links.

Communications network 110 permits data transmission between various devices within the system, including drone 100, server 120, database 130 and user interface module 140. Communications network 110 can include the Internet, as well as cellular data networks, Wi-Fi transceivers, or local area networks.

Server 120 hosts application logic 122 for, inter alia, processing imagery data received from drone 100 and outputting reports. In some embodiments, server 120 can include one or more GPU or inference processors for efficient computation. Server 120 is operationally connected to database 130 for data retrieval and archiving. Database 130 stores, inter alia, training datasets, orthophotos, processed results, and historical inspection data. Database 130 facilitates the retrieval of previous flight data for model training and validation. The term “database” is used herein broadly to refer to an indexed store of data, whether structured or not, including without limitation relational databases and document databases.

In certain embodiments, application logic 122 can also implement a variety of other functionalities that can facilitate operation of the systems and methods described herein, such as, for example, messaging services, web services, or API endpoints.

While depicted in the schematic block diagram of FIG. 1 as block elements with limited sub elements, as known in the art of modern web applications and network services, server 120 can be implemented in a variety of ways, including in a distributed computing environment where tasks are performed by remote processing devices that are linked through a communications network. In a distributed computing environment, program modules can be located in either or both local and remote computer storage media including memory storage devices. That said, the implementation of server 120 will typically include, at some level, one or more physical servers, at least one of the physical servers having one or more microprocessors and digital memory for, inter alia, storing instructions which, when executed by the processor, cause the server to perform methods and operations described herein.

User interface module 140 can be utilized by individuals for communication with other system components, including server 120. User interface module 140 can provide access to processed results and generated reports, as described herein. User interface module 140 can include a web-based dashboard, or a mobile application operable on a user device such as a smartphone or tablet computer. Users can utilize user interface module 140 to view roof condition assessments, damage localization, and recommended repairs.

Those of ordinary skill in the art can appreciate that FIG. 1 depicts the various computing devices and environments in a simplified manner for purposes of clarity, and practical embodiments can include additional components and suitably configured processing logic to support known or conventional operations and functionality not described in detail herein.

In other embodiments, the present disclosure is directed to a system for assessing a spatial area, such as a structure, based on an at least one condition, comprising: a drone 100 configured to capture aerial images; a computing device equipped to process the images into 3D models and 2D orthomosaics; a machine learning module configured to analyze the models and mosaics to assess the spatial area based on the at least one condition; and identify instances of the at least one condition. In certain embodiments the spatial area is a roof; and the at least one condition is damage to the roof.

In further embodiments the machine learning module comprises models that are particularly designed based on any of the following: the material type of the roof, unique material characteristics, the color characteristics of the roof, specific color patterns and anomalies; or pre-determined color ranges that correlate with specific types of damage. The machine learning can be a convolutional neural network (CNN) such as U-Net specialized for feature detection on shingles, or an object detection network that outputs bounding boxes or masks for damage spots. The types of roof damage that can be detected include, but are not limited to: hail Damage—damage to a roof caused specifically by hail as opposed to other causes; Missing or Displaced Shingles—areas where shingles have been torn off or are visibly absent, often appearing as irregular gaps or different-colored patches on the roof; Damaged or Cracked Shingles—shingles that remain in place but have cracks, tears, or impact marks, these might manifest as localized discoloration, texture change, or dark spots (in the case of hail hits bruising the shingles); Granular Loss—regions where the protective granules on asphalt shingles are worn away (possibly from hail impact or aging), detectable by changes in color tone or increased reflectivity in imagery; Debris or Punctures—foreign objects (for example, a fallen branch) or puncture marks on the roof surface causing visible damage or holes (if the resolution allows detection); and other anomalies—for example, lifted edges, bent flashing, or sagging areas that could indicate structural damage beneath the roof covering.

In certain embodiments a system of the present disclosure further comprises: a module to assign a score to each identified damage, the score based on the severity and potential impact of the damage, and to categorize the overall health of the roof into multiple classes based on the aggregate scores. The classes can include, for example, a red class, indicating substantial damage justifying immediate repair or replacement actions; a yellow class, indicating moderate damage that can require substantial repairs but not immediate replacement; and a green class, indicating minimal or no significant damage, suggesting routine maintenance. The system can further comprise an apparatus that provides dynamic updates to homeowners or property managers about the condition of their roof via digital communication methods, including but not limited to emails, application notifications, or web-based dashboards.

In certain embodiments a system herein further comprises: a non-transitory computer-readable medium having instructions stored thereon that, when executed, cause the computing device to perform operations comprising processing images captured by a drone to extract features indicative of roof damage, and the machine learning module to implement a hierarchical series of machine learning models that analyze the extracted features based on the type and color of the roofing material. In certain embodiments, the operations on the non-transitory computer-readable medium can further comprise: generating a normalized score for the roof based on detected damage types and their severities, where the score is adjusted by the potential impact of each damage type. The score and the damage types can be used to automatically generate and periodically update an interactive map accessible to roofing contractors, the map comprising detailed property information and recommended actions.

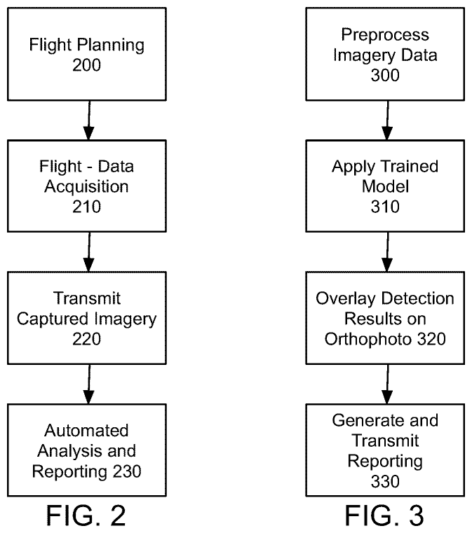

FIG. 2 illustrates an exemplary and non-limiting method of utilizing a system of FIG. 1. Operation begins with flight planning (step 200) for deployment of drone 100 to survey structures (such as home rooftops) in a desired region. In some implementations, flight paths can be pre-programmed into onboard processor 103 of drone 100 using waypoints defined by GPS coordinates, with altitude, speed and camera settings optimized to ensure comprehensive coverage and image clarity. In other implementations, flight paths for drone 100 can be manually controlled by a drone pilot. Geographic regions for flight operations can be selected based on a variety of criteria, including but not limited to: time elapsed since prior collection of imagery, recent weather events likely to cause structural damage, absence of snow or other conditions potentially obscuring imagery, or compatibility of current weather conditions with flight. In some embodiments, building permit information specifying the age of building roofs can be utilized to select roofs for inclusion in a flight path. Other data sources that can be used include storm damage reports from meteorological services, and property value assessments from tax assessors.

As shown further in the exemplary embodiment of FIG. 2, in step 210, drone 100 is operated for data acquisition. For example, drone 100 can execute flight paths determined in step 200, whether autonomously or under remote pilot supervision or control. During flight, camera 101 captures imagery (which can include still images, video, or combinations thereof) of the roof structured at selected locations. Imagery can be geotagged with GPS coordinates from GPS module 102. Typically, imagery will be stored by drone 100 in on-board storage during flight.

In step 220, captured imagery and associated metadata is transmitted from drone 100 to server 120 via communications network 110. For example, in some embodiments, captured imagery stored by drone 100 in onboard storage can be first offloaded to a user computing device (such as a laptop computer, smartphone or tablet computer), which device can subsequently transmit the imagery data to server 120. In other embodiments, transceiver 104 of drone 100 can facilitate wireless communication of imagery data directly to server 120. In some embodiments, drone 100 can transmit captured imagery data to server 120 or a user computing device while in flight (e.g., simultaneously with step 210); and in other embodiments, imagery data can be transmitted after a flight is completed.

Upon receiving imagery data, server 120 initiates an automated analysis process to evaluate structure condition (step 230). FIG. 3 provides further detail of an exemplary process for automated analysis of flight imagery data. In this step 300, server 120 executes data preprocessing steps. In some embodiments, preprocessing can include stitching a plurality of images to create an orthophoto, i.e., a geometrically corrected top-down image that represents a portion of the Earth's surface, eliminating distortions caused by camera angles. Orthophotos can be generated using aerial photogrammetry techniques and have been observed to serve as a consistent basis for analysis and model application. In some embodiments, preprocessing in step 300 can include use of imagery data to generate three-dimensional models of building roofs or other structures. Substeps can include, inter alia, one or more of image measurement, image alignment, triangulation, and orthorectification. In certain embodiments, other preprocessing steps can include noise reduction, contrast enhancement, and normalization to improve model accuracy.

As shown step 310, in certain embodiments, a trained machine learning model is applied to the orthophoto (or, if available, 3D structures models) created in step 300, to identify and classify roof damages and other features of interest. In some embodiments, the roof 3D models or 2D orthomosaics can be processed to segment the roof into identifiable boundaries based on geometric (such as hard boundaries, particularly the eaves and rakes of roofing systems to define start and end points between “roof” and “non roof”) and photometric (pixel or color differences, harsh changes in near/neighboring pixel values along detected edges) properties, classify types and colors of roof materials detected within the segmented boundaries, and detect and categorize damage within the identified roof boundaries based on predefined damage characteristics. Such damage can include, for example, identifying missing shingles (such as can be characterized by gaps in typical shingle patterns), identifying damaged shingles (as can be evidenced by irregularities in texture or color compared to undamaged areas), or identifying granular loss through changes in surface reflectivity and texture consistency.

In some embodiments, the damage assessment of step 310 can include generating a damage score to each identified damage. The damage score can reflect the severity and potential impact of the damage. The overall condition of a roof can then be classified into multiple health classes based on the aggregate damage scores. Such techniques can be utilized, e.g., to prioritize roofing and repair operations. In some embodiments, roof health class can be color coded, such as, for example, a red class indicating substantial damage justifying immediate repair or replacement actions; a yellow class, indicating moderate damage that may require substantial repairs but not immediate replacement; and a green class, indicating minimal or no significant damage, suggesting routine maintenance.

As shown in step 320, detection results from step 310 can be overlaid on the orthophoto, providing visual localization of issues. In some embodiments, detected features can be overlaid on 2D imagery, or 3D models, of a structure's roof, so that missing shingles or other damage can be readily located with high spatial accuracy. The model's output can be compared with ground truth data to validate accuracy. In certain embodiments, such output can help facilitate highly targeted repairs and maintenance planning.

As shown in step 330, server 120 can generate one or more comprehensive reports indicating the condition of the building roof. The report can include any of the following: identified damage, their locations, severity levels, or suggested repair actions. In some applications, users can access such reports generated in step 330 via user interface module 140, which can support data visualization tools such as interactive maps and charts. For example, a roofing contractor can visit an individual's home and, using a tablet computer, show the homeowner direct imagery of the home's roof condition with detailed illustration of damages and suggested repairs.

In some embodiments, roof damage assessments can include an estimate of the type and quantity of roofing material required for any suggested repair or replacement.

Reports from step 330 can additionally or alternatively be transmitted via email or messaging or can be accessible via website. On some embodiments, systems and methods herein can provide periodic and dynamic updates directly to homeowners or property managers about the condition of their roof; such updates can be provided via digital communication methods (including, without limitation, emails, application notifications or web-based dashboards) or mailed to the property address via postal mail.

In some embodiments, reporting output in step 330 can be made available to roofing contractors on a dynamic electronic map. The map can combine report data (e.g., damage score, color classifications, or the like) overlaid with publicly-available information (such as property address, owner information, assessed tax value, and the like). Such a map can be utilized by roofing contractors to identify locations requiring services, and communicate service requirements to property owners and managers.

In certain embodiments, reports can be generated in step 330 that are particularly suited for insurance carriers or insurance adjusters. Such reports can include, for example, detailed imagery of damage, assessment of damage, recommendations for repair or replacement, square footage affected, and estimates of building materials required.

In certain embodiments, the machine learning model implemented in step 310 will be trained specifically to identify structural issues of interest, such as roof damage. For roof damage analysis, multiple neural network models have been evaluated to determine the most effective architecture. In certain embodiments, the model utilizes a Faster Region-Based Convolutional Neural Network (Faster R-CNN) as the primary neural network, with ResNet-50 as the backbone model. Faster R-CNN is an effective object detection model that efficiently identifies objects within images. ResNet-50 provides a deep convolutional network that can be effective in addressing the vanishing gradient problem, permitting the training of very deep networks. This combination results in high accuracy and reliability in detecting roof damage.

In certain embodiments, the detailed reports output in step 330 can be directly utilized by roofing professionals, insurance adjusters, or property owners, providing them with actionable insights into roof conditions. This automated approach can not only enhance the accuracy and efficiency of roof inspections, but also significantly reduce the time and labor typically involved in manual roof examination processes. As such, embodiments can be used to revolutionize the practices of roof inspection and damage assessment by introducing a scalable, cost-effective, and highly accurate technological solution.

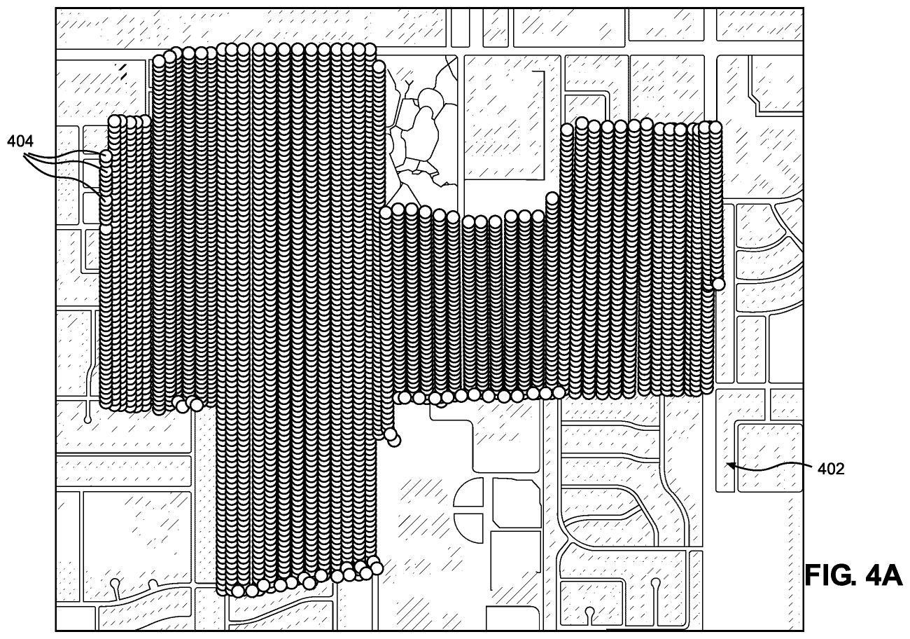

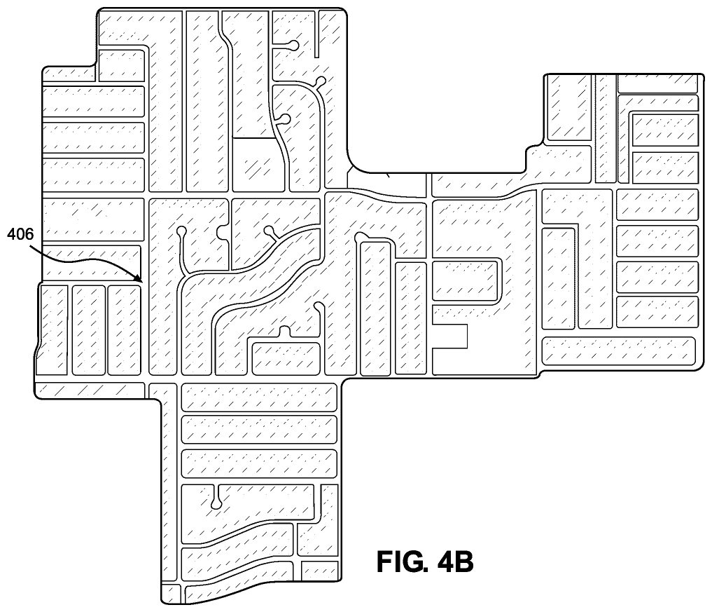

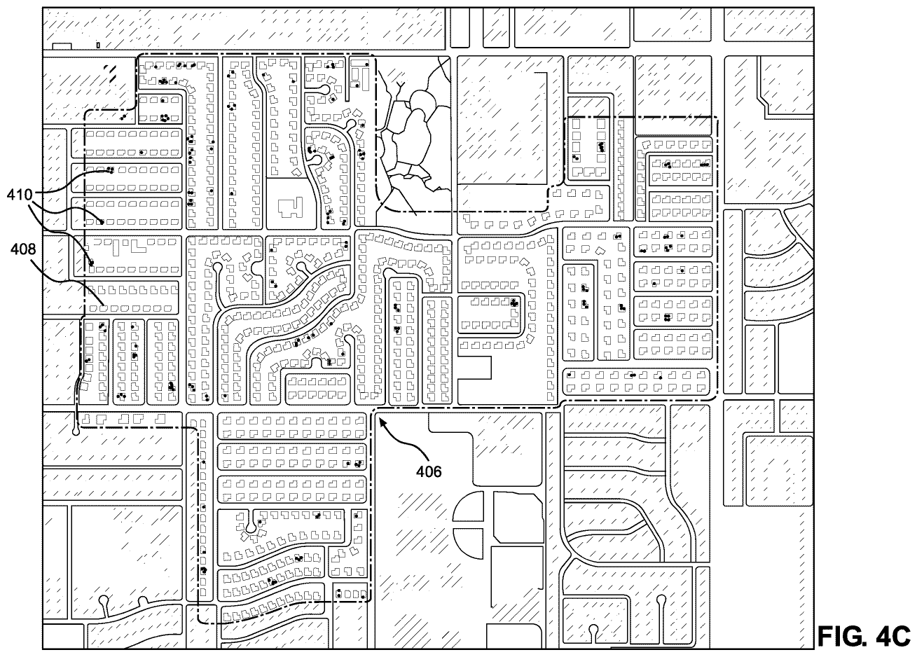

FIGS. 4A, 4B, and 4C illustrate other embodiments of the present disclosure. FIG. 4A shows an exemplary image capture 404 map of an unmanned aerial vehicle (UAV) equipped with photogrammetric imaging technology; capturing aerial images of a spatial area 406 within a geographically selected region 402. Any one or more of the images capture 404 taken by the drone can be done at high speed. The density of the image captures 404 can be determined by a processor based on at least the speed and height of the drone, the resolution and type of imaging technology (for example, infrared, radio, traditional, or the like), or the flight conditions. The density can be determined to ensure enough coverage in the images such that the resulting three-dimensional model and two-dimensional (2D) orthomosaic do not have significant gaps.

FIG. 4B shows a resulting two-dimensional (2D) orthomosaic of the spatial area 406 generated from the captured images. FIG. 4C shows the two-dimensional (2D) orthomosaic of the spatial area 406 segmented into identifiable boundaries 408, here roof tops, and detected instances of the at least one condition 410, here roof damage. By way of example, in the embodiment of the present disclosure illustrated in FIGS. 4A, 4B, and 4C, the geographically selected region 402 is a town, the spatial area 406 is a neighborhood, the identifiable boundaries 408 are roof tops, and detected instances of the at least one condition 410 are roof damage.

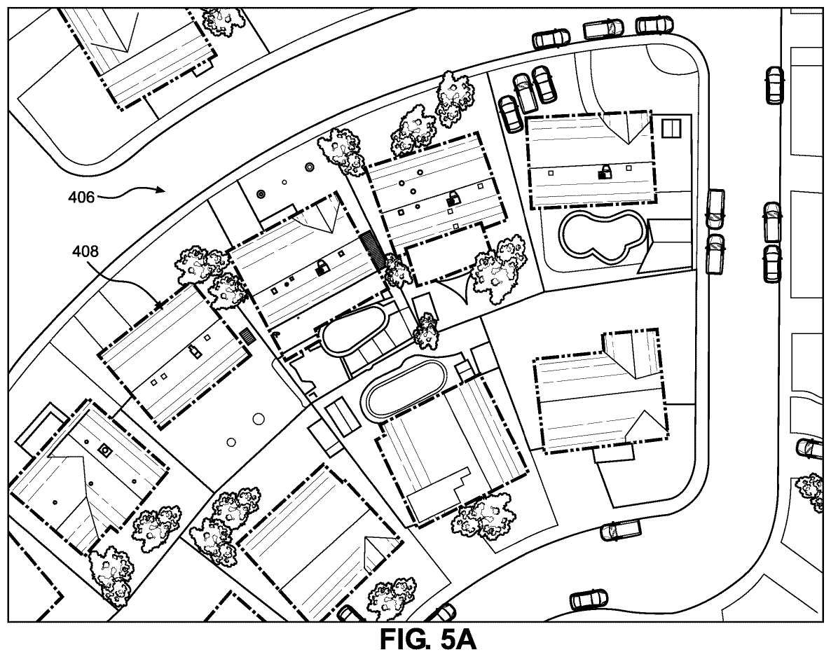

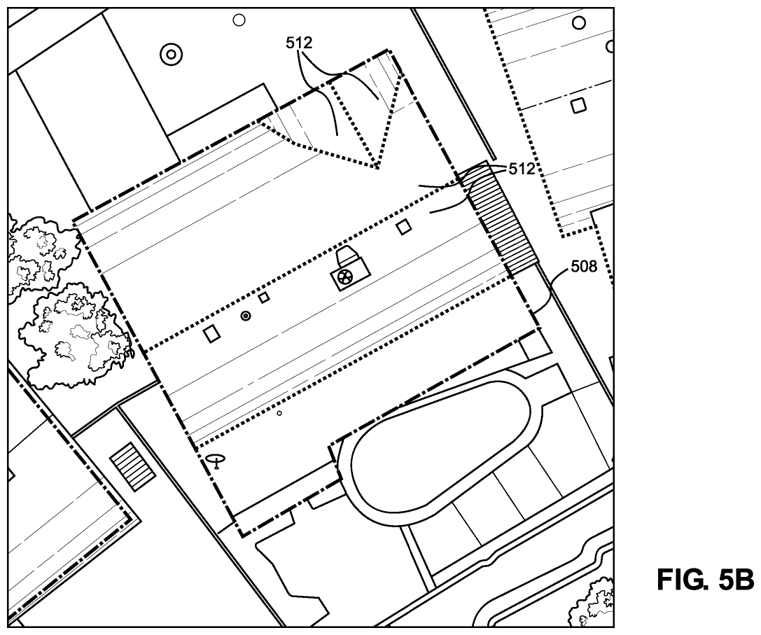

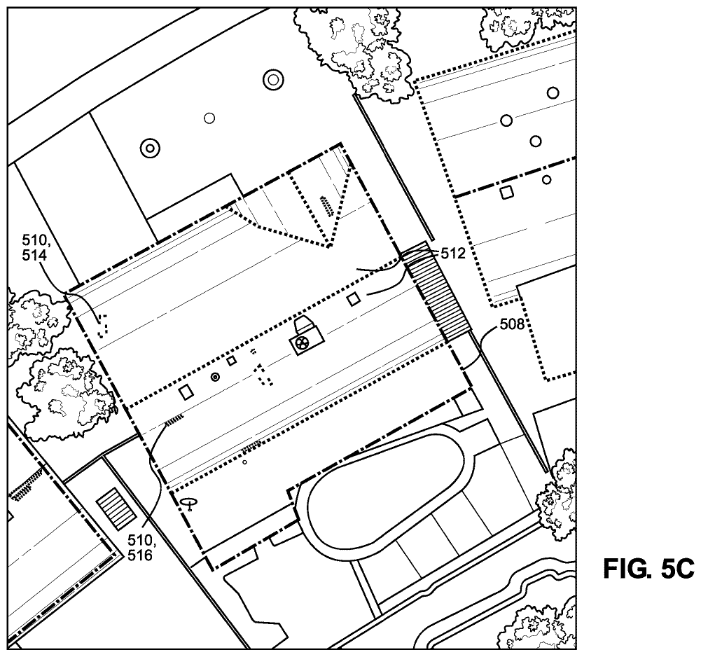

FIGS. 5A, 5B, and 5C illustrate further exemplary embodiments of the present disclosure. FIG. 5A shows an embodiment of a two-dimensional (2D) orthomosaic of the spatial area 506 generated from captured images segmented into identifiable boundaries 508, here roof tops with a plurality of slopes. FIG. 5B shows the identifiable boundaries 508, here roof tops further segmented into roof slopes 512. FIG. 5C shows the identifiable boundaries 508, here roof tops further segmented into roof slopes 512 and detected instances of the at least one condition 510, here roof damage, categorized by severity of damage, (mild 514, and severe 516)

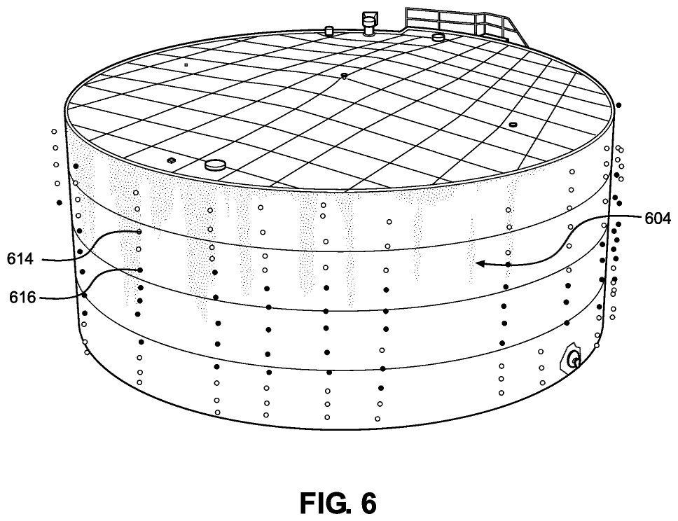

FIG. 6 illustrates an embodiment of the present disclosure showing a two-dimensional (2D) orthomosaic of a spatial area 604 graded based on one condition (good 614, bad 616). By way of example, in the embodiment of the present disclosure illustrated in FIG. 6, the geographically selected region is an oil field, the spatial area 604 is an oil holding tank, and detected instances of the at least one condition 614, 616 are tank wall density.

In other embodiments of the present disclosure, the geographically selected region is a city block, the spatial area is a building, the identifiable boundaries are different floors within the building, and detected instances of the at least one condition is the presence of HVAC based on infrared imaging. In other embodiment of the present disclosure, the geographically selected region is a forest, the spatial area is a particular patch of trees, and detected instances of the at least one condition is presence of tree blight. In other embodiment of the present disclosure, the geographically selected region is a lawn, the spatial area is a flower bed, the identifiable boundaries are different plants within the flowerbed, and detected instances of the at least one condition are the presence of fruit. This is not a comprehensive list of applications the embodiments of the present disclosure can take, but rather is a representative sample.

In certain embodiments, the present disclosure is directed to a method for assessing a spatial area based on an at least one condition, comprising: deploying an unmanned aerial vehicle (UAV) equipped with photogrammetric imaging technology; capturing aerial images of a spatial area within a geographically selected region, wherein the region is selected based on data indicating potential of the at least one condition 410; processing the captured images to generate three-dimensional (3D) models and two-dimensional (2D) orthomosaics of the spatial area; and analyzing the generated 3D models and 2D orthomosaics using a machine learning algorithm configured to detect the at least one condition 410. In certain embodiments the data can include, for example, at least one of the following: building permit information specifying the age of the roof, storm damage reports from meteorological services, and property value assessments from tax assessors.

The multiple data sources can include, for example, meteorological records (such as hailstorm reports, wind event logs, lightning strike data, or the like), possibly obtained from weather services, radar datasets, or specialized storm tracking databases; historical weather maps or footprints (for instance, maps of hail size distribution for a given storm, which can show the hail size that fell on the specific neighborhood); building permit and maintenance records for the property (e.g., the date the roof was last replaced or repaired, roofing material used, warranty information, property value assessments from tax assessors or the like) and insurance claim history (if accessible), which might show previous claims for roof damage at that address.

As a practical application, the system can match each type of damage detected with a likely causative event. For example, if the damage detection found numerous circular impact marks consistent with hail, the system will look up hail events that impacted the property's location after the roof's installation date. It might be found that on May 5, 2024, a hailstorm with 2-inch diameter hail stones passed over the region. If the size and pattern of the detected impacts correspond to damage typically caused by ˜2-inch hail, the system can confidently link the roof's damage to that storm. It may record May 5, 2024—Hail, 2″ diameter as the date of loss for that damage. If multiple hail events occurred, the system might choose the event most likely to have caused the observed damage (usually the most recent severe event).

Similarly, for wind damage: suppose the system detected many missing shingles predominantly on the northwestern slopes of the roof. The historical data might show that on Sep. 13, 2025, a severe wind event (e.g., a tornado or microburst) with 80 mph winds from the northwest hit the neighborhood. The system would correlate the missing shingles to that event, noting that the wind direction and speed align with the damage pattern (northwest-facing slopes affected by strong NW winds). Thus, it would attribute the missing shingle damage to the Sep. 13, 2025 windstorm. The system effectively performs an automated forensic analysis, tying each observed damage pattern to a cause.

A notable filter in this process is the roof's known installation or replacement date. If the roof was newly installed in 2022, any hailstorms from earlier years (e.g., 2020) can be ignored since any damage from those would have been removed with the old roof. The system can use the permit data to ensure it only considers events during the roof's lifespan. If the roof was replaced in sections at different times, the system can even consider each section's age if that data is available.

By correlating damage with weather events, a method or system herein can add tremendous value for insurance and repair applications. It can provide evidence that the damage was caused by a covered peril (like a hailstorm on a certain date), which is often required for insurance claims. It can also help distinguish old damage from new damage—for instance, if some damage is found but no corresponding event is identified in the data, it might suggest the damage is due to long-term wear or a non-storm cause (which might not be covered by insurance or could indicate a maintenance issue). Insurance companies currently have no means to assess all damage across a roof and determine what was actually caused on a filed date of loss. When anomalies are identified and validated, a method or system herein can retain from that moment an accurate measurement of the square footage of that anomaly. This is particularly relevant in hail damage assessment. By way of example, if a roof exists in a state with a one year statute of limitations for insurance claims and two years ago a storm hit with 1.5 inch hail but this year, a storm hit with 0.75 inch hail, the only storm still viable for assessment is the storm within this year (the 0.75 inch event). In most situations, both sizes of hail strikes would be tabulated as having affected a property on that date. The few times carriers segment between strikes on different dates of loss are when the spread in intensity between the two events is even more stark. A method or system herein can provide an accurate assessment shingle by shingle, hail hit by hail hit, across the roofing system, and delineate between damages accrued on different dates and time.

In further embodiments, a method herein further comprises analyzing the generated 3D models and 2D orthomosaics using a machine learning algorithm configured to detect the at least one condition. In certain embodiments, this analyzing step comprises: segmenting the spatial area into identifiable boundaries based on geometric (such as hard boundaries, particularly the eaves and rakes of roofing systems to define start and end points between “roof” and “non roof”) and photometric (pixel or color differences, harsh changes in near or neighboring pixel values along detected edges) properties; classifying types and colors of materials detected within the segmented boundaries using models trained on a data set comprising numerous types and colors of material; and detecting and categorizing the at least one condition within the identified segmented boundaries based on predefined characteristics of the at least one condition. By way of example, in certain embodiments of the present disclosure the geographically selected region is a town, the spatial area is a neighborhood, the identifiable boundaries are roof tops, and detected instances of the at least one condition are roof damage.

In certain embodiments, the at least one condition is roof damage; and the predefined characteristics of the roof damage can include any of the following: missing shingles characterized by gaps in typical shingle patterns, damaged shingles evidenced by irregularities in texture or color compared to undamaged areas, or granular loss through changes in surface reflectivity or texture consistency. In further embodiments the imaging can be done across the electromagnetic spectrum, including infrared, x-ray, radio waves, or the like. This can allow for other characteristics can be considered including but not limited to temperature, material identification, density, or structural defects.

Insurance industry practices for hail and storm damage rely on slope-specific evaluations of roofs. Adjusters traditionally mark off test squares (often 10 ft by 10 ft) on each roof slope to count damage such as hail hits. If the damage within a 100 sq. ft. area exceeds a certain threshold (commonly around 8 hits for hail on asphalt shingles), that slope is deemed significantly damaged and could qualify for replacement. This standard procedure, pioneered in the 1960s, ensures that damage is quantified per directional slope and that claims decisions (repair vs. replace) are based on localized damage rather than roof-wide averages.

It has become a universal benchmark to minimize disputes, as each slope is assessed under criteria (e.g., functional damage definition and hit count). However, existing automated roof damage assessment systems often fail to mirror this slope-specific approach. Some AI-based inspection tools analyze the roof as a whole, effectively producing a global average damage metric for the entire roof. For instance, previously known drone inspection platforms can survey a roof and produce an overall damage report in minutes, sometimes forgoing the traditional test-square sampling. While this whole-roof analysis is fast, it can overlook uneven damage distribution—one slope might be heavily damaged while others are relatively intact. A single aggregated score might understate severe damage isolated to one facet. In contrast, human adjusters would capture that by evaluating each slope individually. Moreover, simply averaging damage signs across a roof can mis-classify claims eligibility, e.g., if one slope has dense hail hits but others have few, a global average might fall below the approval threshold even though part of the roof clearly warrants replacement.

Another challenge is the precision of roof segmentation. Previously known image-based roof analysis shows the feasibility of segmenting roof images into their constituent planes. For example, an automated system can separate a roof image into individual planar sections (slopes) using image segmentation techniques. Academic approaches combine edge detection and region segmentation to identify roof facets in aerial imagery. These methods demonstrate that roof geometry can be parsed from photos or LiDAR: edges (like ridges and hips) are detected and regions between them are labeled as distinct slopes. However, such segmentation can be error-prone due to roof details (vents, dormers, or the like) causing false edges or broken regions. Smoothing and refinement steps are often needed to achieve clean facet separation.

Additionally, while 2D image segmentation provides approximate boundaries, 3D data (e.g., photogrammetric point clouds or LiDAR scans) can greatly improve accuracy by clustering points into planar roof facets. A combination of 2D and 3D segmentation has not been fully leveraged to robustly isolate each slope for targeted analysis.

There remains a need for an end-to-end system that (1) automatically delineates all observed slopes of a roof, (2) evaluates damage on each slope with algorithms that weight severity appropriately, and (3) flags each slope against claim criteria (like the 8-hit rule) to permit or automate decisions.

In summary, the limitations in previously known systems include: (a) reliance on global damage metrics that could dilute localized severe damage, (b) incomplete or imprecise roof segmentation (treating a complex roof as one unit or having segmentation errors), and (c) lack of direct integration with insurance-approved damage thresholds on a per-slope basis. These gaps result in less accurate claims outcomes and still often require manual review.

In certain embodiments, the present disclosure addresses these issues by introducing a slope-based segmentation method (using 2D and 3D data) combined with per-slope damage scoring and test-square-level analysis, thereby aligning automated assessments with the rigorous standards of insurance adjusters and roofing professionals.

In certain embodiments, the present disclosure is directed to a method and system for automated roof damage assessment that operates on a per-roof-slope basis, greatly enhancing accuracy and actionability of results. In contrast to prior “one-size-fits-all” averaging techniques, this solution partitions a roof into its individual slopes (facets) and evaluates each separately.

According to one aspect, the system ingests imagery of a roof (from unmanned aerial vehicles—UAVs/drones, satellites, or ground cameras) along with optionally a 3D model or point cloud of the roof. A two-dimensional (2D) segmentation module applies edge-detection algorithms to a georeferenced image (e.g., an orthomosaic or geoTIFF) of the roof to identify lines corresponding to roof ridges, hips, and edges. This yields an initial division of the roof by aspect (each facet corresponding to a different orientation). Detected edges are then refined by a smoothing process—small spurious edges caused by roof features like vent pipes, skylights, or AC units are eliminated or merged. The result is a segmented roof layout where each significant slope is separated.

In tandem, a three-dimensional (3D) segmentation module uses depth information (such as a LiDAR point cloud or a photogrammetric reconstruction from multiple images) to cluster roof points into planar groups. Planar roof sections are distinguished by fitting planes to point clusters; points lying on the same plane (within tolerance) form one roof slope. This 3D approach corrects and validates the 2D segmentation. It provides enhanced precision at valleys and pitch breaks, ensuring that each slope's boundaries are accurately mapped even when color/texture in the 2D image might not distinguish them. By combining 2D edge detection with 3D plane-fitting, the system achieves highly accurate slope-by-slope segmentation even on complex roofs with many sections.

Each identified slope can then be analyzed individually for damage. The system employs computer vision (potentially AI/machine learning models trained to detect roof damage) to locate and classify damage instances on a per-slope basis. For example, it can detect hail impact marks, missing or lifted shingles, wind crease lines, and other defects in the images of that slope. Rather than summing these findings over the whole roof, in certain embodiments, the present technology computes a damage score for each slope. A new weighted algorithm can be applied: different damage types and severities are assigned weights reflecting their impact on overall roof integrity and claim severity. For instance, a large hail strike that penetrates the shingle mat might be weighted more than superficial granule loss, and a missing shingle (from wind) might carry a higher weight than a small hail bruise. The score can also factor in the density of damage (clustering of hits) on that slope. This per-slope scoring algorithm produces a quantitative measure (or grade) of damage for every roof face, which is far more granular than a single global average. It can ensure that a heavily damaged slope will stand out with a high score even if other slopes are lightly damaged—something that a global method could obscure.

Certain embodiments of the present disclosure can integrate the concept of standard test squares (10 ft×10 ft areas) into the analysis. For example, for each slope, the software can identify one or more test areas of 100 sq. ft. (matching the definition of an insurance test square) within that slope's boundaries. These virtual test squares can be positioned in regions with the most severe damage density (analogous to an adjuster choosing the worst-looking area on a slope for inspection. Within each test square, the system counts the number of damage hits (e.g., hail impacts that meet the functional damage criteria). This count is directly compared to predetermined thresholds used by insurers—for example, 8 hits in 100 sq. ft. as a common benchmark for hail claims. In certain embodiments, a system or method herein can use elevation data derived from the 3D model to correct the flat 10×10 view of the 2D orthomosaic to the appropriate position, length, and width in accord with the roof's slope. A flat 2D projection of a 10×10 square on a roof would yield inaccurate representation of a true 10×10 footprint at that location in real life. By correcting the 10×10 square the results can be more true and accurate.

If the count meets or exceeds the threshold, the system can register, for example, a “red trigger” for that slope. A “red trigger” in this context is a flag indicating that the slope's damage surpasses the accepted tolerance and that slope would qualify for replacement under typical insurance guidelines. In practice, the output might label that slope in red on a report or user interface to immediately draw attention to its status.

In certain embodiments, the use of these red triggers can permit automated decision-making. When one or more slopes are flagged (red) as exceeding damage criteria, the system can automatically determine that a full roof replacement claim should be approved (since most policies would cover the roof if at least one slope is significantly damaged, and certainly if multiple slopes are).

Conversely, if no slope hits the threshold, the system can recommend repair or no claim, or possibly indicate, for example, a yellow caution if damage is present but below threshold (for example, 5-6 hits in the square could be a yellow status—damaged but not enough per standards). These graduated indicators (e.g., green=no significant damage, yellow=moderate, red=severe) can, in certain embodiments, transform raw damage data into actionable categories aligned with insurance criteria.

In another aspect, an embodiment herein comprises a complete system implementation including any of the following: a UAV or camera system to capture roof images, a data processing pipeline (which can run on a cloud server or on the drone's onboard computer or a mobile device) that executes the slope segmentation and damage scoring, and an output interface. The output can be a detailed report showing each slope's score, damage map, and whether it triggered the threshold. The report can include annotated images of each slope with damage marked, and a summary table listing slopes (identified e.g., by orientation or number) with their damage scores and trigger status. In this way, an insurance carrier or contractor receives an objective, repeatable, and clear assessment that directly corresponds to how claims are evaluated.

In certain embodiments, the present disclosure effectively automates the role of an expert adjuster: segmenting each slope, “looking” for damage, applying the same tests (counting hits in a square) that a human would, and then outputting a decision criterion (approve/deny or replace/repair) with supporting details. By improving upon global averaging methods, the slope-based system prevents dilution of localized damage and ensures that no severely compromised slope goes unnoticed. This leads to fairer and faster claim resolutions. It also substantially reduces the need for on-site climbs and manual chalk-marking, enhancing safety and scalability.

Novel features include: (1) Precision—roof analysis at the granularity of individual slopes yields more accurate damage assessments; (2) Alignment with Insurance Standards—incorporating 10×10 test squares and hit thresholds means the results are immediately interpretable by insurance professionals (e.g., “Slope 1 has 12 hail hits in test area—exceeds 8-hit threshold”); (3) Automated Scoring Algorithm—weighted damage scoring per slope offers a more nuanced evaluation than a simple count or yes/no, allowing differentiation between, say, an older slope with moderate hail vs. a newer slope with the same hits (weights could be tuned for material type or age, or the like); and (4) Scalability—ideal for post-storm assessment of entire neighborhoods via drones, where hundreds of roofs can be processed quickly and consistently, drastically cutting down the time and cost compared to dispatching adjusters to each property.

In certain embodiments the spatial area comprises at least one roof; e.g., a roof having a plurality of slopes; the at least one condition is damage to roof; and processing the captured images to generate three-dimensional (3D) models and two-dimensional (2D) orthomosaics of the spatial area comprises: treating the image data with an edge-detection model to identify roof ridge lines and boundaries, thereby segmenting the roof into individual slopes in a two-dimensional segmentation; constructing a three-dimensional model of the roof from the image data or separate depth data, and segmenting the three-dimensional model into planar facets corresponding to the roof slopes; and refining the two-dimensional segmentation using the three-dimensional model to produce an accurate identification of each roof slope. In certain embodiments treating the image data with an edge-detection model further comprises filtering out false boundaries caused by an at least one roof accessory via a smoothing process. The three-dimensional model can be derived from aerial LiDAR point cloud data or stereophotogrammetry, and planar facets are segmented by fitting planar surfaces to the point cloud representing the roof. In further embodiments, the disclosed method further comprises using a trained deep learning model to identify hail impact marks and classifies each impact by severity and further detects missing or creased shingles due to wind.

In a further embodiment analyzing the generated 3D models and 2D orthomosaics using a machine learning algorithm configured to detect the at least one condition further comprises: evaluating each roof slope independently to detect instances of damage on that slope using an image analysis algorithm, wherein damage instances include at least hail impact marks or wind-created shingle damage; for each roof slope, defining at least one virtual test area of predetermined size on the slope, the test area corresponding to approximately 100 square feet on the slope surface; computing a damage metric for each roof slope, including creating a count of the number of detected damage instances within the at least one virtual test area on that slope; comparing the count to a threshold number of damage instances predefined for said predetermined size area; and classifying the roof slope as significantly damaged if the threshold is met or exceeded, and as not significantly damaged if the threshold is not met, thereby producing a per-slope classification aligned with insurance criteria for damage assessment. In certain embodiments, computing the damage metric includes applying a weighted algorithm that assigns different weights to different damage types or severities, to produce a composite damage score for each slope beyond a simple count of instances. The weighted algorithm can assign a higher weight to damages that fully compromise roofing material (missing shingles, punctures) and a lower weight to superficial damages (surface granule loss), such that the composite score reflects the overall impact on the roof slope's integrity.

In a further embodiment, defining the virtual test area comprises selecting a region of the roof slope with the highest density of damage instances and mapping an area of 10 ft by 10 ft on the slope surface around that region, accounting for the slope's pitch and orientation, such that the area is 100 square feet in the plane of the slope. The threshold number of damage instances can be configurable and defaults to eight (8) hail impact marks per 100 square feet for hail damage on asphalt shingle roofs and wherein meeting or exceeding this threshold triggers a classification of the slope as requiring replacement. In certain embodiments, the disclosed method further comprises generating a report or data output that identifies each roof slope and indicates whether it is classified as significantly damaged, wherein slopes meeting the threshold are marked in a first visually distinguishable manner (as a “red trigger” indicating severe damage) and slopes not meeting the threshold are marked in a second manner (e.g., green or yellow indicating mild or moderate damage). Multiple roof slopes classified as significantly damaged can automatically trigger a recommendation for full roof replacement, whereas a single slope classified as significantly damaged can trigger a recommendation for partial roof repair or replacement limited to that slope, in accordance with insurance claim practices.

In another embodiment, the present disclosure is directed to a method of quantifying at least one condition, comprising: capturing aerial images of a spatial area using an unmanned aerial vehicle (UAV) equipped with photogrammetric imaging technology; processing the captured images to generate segmented two-dimensional (2D) orthomosaics and three-dimensional (3D) models of the spatial area; analyzing the segmented images to determine an at least one portion of the spatial area affected by the at least one condition; quantifying a score for the at least one boundary of the spatial area affected by the at least one condition based on the analysis; and generating a tabulated report that lists the quantified score, the area of the at least one portion affected, and recommended actions. By way of example, in certain embodiments of the present disclosure, the spatial area is a neighborhood, the at least one boundary is a roof; and the at least one condition is damage to the roof.

In certain embodiments, the at least one condition is damage to the roof; the at least one portion is the square footage of the roof affected by damage; the score is the amount of roofing material that needs repair or replacement; and wherein the segmentation is based on predefined criteria that differentiate between no damage, medium damage, and severe damage to the roof. The report can be formatted to facilitate direct use by roofing professionals or insurance adjusters for making decisions regarding roof maintenance and claims processing. In certain embodiments, the report can be formatted to facilitate direct use by roofing professionals or insurance adjusters for making decisions regarding roof maintenance or claims processing, thereby providing a comprehensive tool for roof assessment that enhances decision-making efficiency and accuracy.

While certain embodiments of the present technology have been described herein in detail for purposes of clarity and understanding, the foregoing description and Figures merely explain and illustrate embodiments of the present technology, and the present disclosure is not limited thereto. It will be appreciated that those skilled in the art, having the present disclosure before them, will be able to make modifications and variations to that disclosed herein without departing from the scope of the technology or appended claims.

We claim:

1. A method of assessing a spatial area based on an at least one condition, the method comprising:
deploying an unmanned aerial vehicle (UAV) equipped with photogrammetric imaging technology;
capturing images of a spatial area within a geographically selected region, wherein the region is selected based on data indicating potential of the at least one condition;
processing the captured images to generate three-dimensional (3D) models and two-dimensional (2D) orthomosaics of the spatial area; and
analyzing the generated 3D models and 2D orthomosaics using a machine learning algorithm configured to detect the at least one condition.

2. The method of claim 1, wherein the analyzing step comprises:
segmenting the spatial area into identifiable boundaries based on geometric and photometric criteria;
classifying types and colors of materials detected within the identified segmented boundaries; and
detecting and categorizing the at least one condition within the identified segmented boundaries based on predefined characteristics of the at least one condition.

3. The method of claim 2, wherein:
the at least one condition is roof damage; and
the predefined characteristics of the roof damage include missing shingles characterized by gaps in typical shingle patterns, damaged shingles evidenced by irregularities in texture or color compared to undamaged areas, or granular loss through changes in surface reflectivity or texture consistency.

4. The method of claim 1, wherein the data includes at least one of the following: building permit information specifying the age of the roof, storm damage reports from meteorological services, and property value assessments from tax assessors.

5. The method of claim 2, wherein:
the identifiable boundaries are at least one roof having a plurality of slopes;
the at least one condition is damage to the roof; and
processing the captured images to generate three-dimensional (3D) models and two-dimensional (2D) orthomosaics of the spatial area comprises:
treating the image data with an edge-detection model to identify roof ridge lines and boundaries, thereby segmenting the roof into individual slopes in a two-dimensional segmentation;
constructing a three-dimensional model of the roof from the image data or separate depth data, and segmenting the three-dimensional model into planar facets corresponding to the roof slopes; and
refining the two-dimensional segmentation using the three-dimensional model to produce an accurate identification of each roof slope.

6. The method of claim 5, wherein treating the image data with the edge-detection model further comprises filtering out false boundaries caused by an at least one roof accessory via a smoothing process.

7. The method of claim 5, wherein the analyzing step further comprises:
evaluating each roof slope independently to detect instances of damage on that slope using an image analysis algorithm, wherein damage instances include at least hail impact marks or wind-created shingle damage;
for each roof slope, defining at least one virtual test area of predetermined size on the slope, the test area corresponding to approximately 100 square feet on the slope surface;
computing a damage metric for each roof slope, including creating a count of the number of detected damage instances within the at least one virtual test area on that slope;
comparing the count to a threshold number of damage instances predefined for said predetermined size area; and
classifying the roof slope as significantly damaged if the threshold is met or exceeded, and as not significantly damaged if the threshold is not met, thereby producing a per-slope classification aligned with insurance criteria for damage assessment.

8. The method of claim 7, wherein computing the damage metric includes applying a weighted algorithm that assigns different weights to different damage types or severities, to produce a composite damage score for each slope beyond a simple count of instances.

9. A system for assessing a spatial area based on an at least one condition, the system comprising:
a drone configured to capture aerial images;
a computing device equipped to process the images into 3D models and 2D orthomosaics;
and a machine learning module configured to analyze the models and mosaics to assess the spatial area based on the at least one condition to identify instances of the at least one condition.

10. The system of claim 9, wherein the spatial area comprises at least one roof; and
the at least one condition is damage to a roof.

11. The system of claim 10, wherein the machine learning module comprises models that are particularly designed based on any of the following: a material type of the roof, unique material characteristics, color characteristics of the roof, specific color patterns and anomalies; or pre-determined color ranges that correlate with specific types of damage.

12. The system of claim 10, further comprising a module to assign a score to each identified damage, the score based on the severity and potential impact of the damage, and to categorize the overall health of the roof into multiple classes based on an aggregate score.

13. The system of claim 12, wherein the classes include: a red class, indicating substantial damage justifying immediate repair or replacement actions; a yellow class, indicating moderate damage that may require substantial repairs but not immediate replacement; and a green class, indicating minimal or no significant damage, suggesting routine maintenance.

14. The system of claim 10, further comprising an apparatus that provides dynamic updates to homeowners or property managers about the condition of their roof via digital communication methods.

15. The system of claim 10, further comprising a non-transitory computer-readable medium having instructions stored thereon that, when executed, cause the computing device to perform operations comprising processing images captured by a drone to extract features indicative of roof damage, and the machine learning module to implement a hierarchical series of machine learning models that analyze the extracted features based on the type and color of the roofing material.

16. The system of claim 15, wherein the operations on the non-transitory computer-readable medium further comprises generating a normalized score for the roof based on detected damage types and their severities, where the score is adjusted by the potential impact of each damage type.

17. The system of claim 16, wherein the score and the damage types are used to automatically generate and periodically update an interactive map accessible to roofing contractors, the map comprising detailed property information and recommended actions.

18. A method of quantifying at least one condition, the method comprising:
capturing aerial images of a spatial area using an unmanned aerial vehicle (UAV) equipped with photogrammetric imaging technology;
processing the captured images to generate segmented two-dimensional (2D) orthomosaics and three-dimensional (3D) models of the spatial area;
analyzing the segmented images to determine an at least one boundary of the spatial area affected by the at least one condition;
quantifying a score for the at least one boundary affected by the at least one condition based on the analysis; and
generating a tabulated report that lists the quantified score, the area of the at least one boundary affected, and recommended actions.

19. The method of claim 18, wherein:
the at least one boundary is a roof;
the at least one condition is damage to the roof;
the score is the amount of roofing material that needs repair or replacement; and
the segmentation is based on predefined criteria that differentiate between no damage, medium damage, and severe damage to the roof.

20. The method of claim 19, wherein the report is formatted to facilitate direct use by roofing professionals or insurance adjusters for making decisions regarding roof maintenance or claims processing.
